(19) United States
(12) Patent Application Publication
(10) Pub. No.: US 2007/0292678 A1
(43) Pub. Date: Dec. 20, 2007

(54) Optical Data Carrier with a Thermochromic Layer

(75) Inventor: Rifat Ata Mustafa Hikmet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,595

(22) PCT Filed: Aug. 30, 2005
(86) PCT No.: PCT/IB05/52833

§ 371 Date: Mar. 2, 2007

(30) Foreign Application Priority Data
Sep. 7, 2004 (EP) 04104311.8

(51) Int. Cl. G11B 7/257

(52) U.S. Cl. 428/328; 428/323

(57) ABSTRACT

The invention relates to an optical data carrier (1, 10) comprising a thermochromic layer (4, 11, 20) including a dielectric transition material (21) and metal nano-particles (22) embedded in said transition material (21) for absorbing at least a part of an irradiation (3) applied to said optical data carrier (1, 10) for reading out data from said optical data carrier (1,10) and/or for recording data on said optical data carrier (1, 10). The invention further relates to an optical master (30) for manufacturing an optical data carrier, said optical master (30) comprising such a thermochromic layer (20, 32). In order to provide an optical data carrier (1, 10) or an optical master (30) with a thermochromic material which allows a choosing of the position of the absorption band and of the temperature at which a thermochromic effect takes place and which is further sufficiently fast and stable, it is proposed that said transition material (21) has a first value of a material characteristic being a specific volume and/or a thermal expansion coefficient of said transition material (21) below a transition temperature (T_{g}, Tₘ) and a second value of said material characteristic above said transition temperature (T_{g}, Tₘ), said second value being higher than said first value.

The invention relates to an optical data carrier comprising a thermochromic layer including a dielectric transition material and metal nano-particles embedded in said transition material for absorbing at least a part of an irradiation applied to said optical data carrier for reading out data from said optical data carrier and/or for recording data on said optical data carrier. The invention further relates to an optical master for manufacturing an optical data carrier, said optical master comprising such a thermochromic layer.

The use of thermochromic materials has been suggested in optical recording for various purposes, such as for enhancing the sensitivity, thus minimizing the size of the recording spot which gives the possibility of a higher density in optical recording, or for multilayer optical recording.

The size of optical spots is limited to a minimum size in relation to the wavelength of the used irradiation. However, even smaller recording spots can be achieved by taking benefit of the fact that the intensity of the optical spot is higher in its center of the spot than in its outer parts.

In order to be able to write on or read from a multilayer optical recording medium, it is necessary to have a high transmission. Furthermore cross-talk between different layers has to be minimized by providing, for instance, an absorption which is a non-linear function of light intensity. In other words, at low intensities the absorbance is substantially constant at a negligible level whereas above a threshold intensity the layer starts to absorb more. This leads to a heating of the layer which may further increase the absorbance of the layer and thus leads to a further heating. This effect is called auto acceleration.

Further details on multilayer optical data carriers and different thermochromic materials to be used in such multilayer optical data carriers are disclosed in WO 2004/023466 (PHNL020794), which is hereby incorporated by reference.

Previously described thermochromic materials can generally be divided into four categories which are organic compound, inorganic compounds, polymers and sol-gel. However, there are limits for use of the materials mentioned above in optical data carriers because of problems concerned with, for instance, stability, speed, position of the absorption band, the temperature above which the thermochromic effect takes place, or the way the thermochromic effect is realized.

It is therefore an object of the present invention to provide an optical data carrier or an optical master with a thermochromic material which allows a selection of the position of the absorption band and of the temperature at which a thermochromic effect takes place and which is further sufficiently fast and stable.

In order to achieve the object an optical data carrier is proposed as claimed in claim 1, wherein said transition material has a first value of a material characteristic being a specific volume and/or a thermal expansion coefficient of said transition material below a transition temperature and a second value of said material characteristic above said transition temperature, said second value being higher than said first value.

Further an optical master for manufacturing an optical data carrier is proposed as claimed in claim 13, wherein said transition material has a first value of a material characteristic being a specific volume and/or a thermal expansion coefficient of said transition material below a transition temperature and a second value of said material characteristic above said transition temperature, said second value being higher than said first value.

The invention is based on the insight that there is a relation between the absorption of nano-particles and the density of the material or medium surrounding these nano-particles. The absorption can effect a change in the density of the surrounding material which can have an effect on the absorption. This effect again may lead to a further change in the density and so on, thus showing an effect which is self accelerating and non-linear.

The extinction coefficient κ, which corresponds to the absorption, for N particles capable of plasmon absorption within a volume V with dimensions substantially smaller than the wavelength of the light to be absorbed is given according to Mie's theory by

$$κ = \frac{18 π NV {ɛ}_{m}^{1.5}}{λ} \frac{{ɛ}_{2}}{{( {ɛ}_{1} + 2 {ɛ}_{m} )}^{2} + {ɛ}_{2}^{2}} , \qquad ( 1 )$$

where ∈₁ and ∈₂ represent the real and the imaginary parts of the material dielectric function and ∈ₘ represents the dielectric constant of the surrounding medium, which is generally assumed to be independent of the wavelength. For further details related to the spectral properties of metal nano-particles and nano-particles in general reference is made to “Spectral Properties and Relaxiation Dynamics of Surface Plasmon Electronic Oscillations in Gold and Silver Nanodots and Nanorods” by Stephan Link and Mostafa A. El-Sayed in J. Phys. Chem. B (1999), 103, 8410-8426, which is hereby incorporated by reference.

Equation (1) is valid for particles with a size of about 50 nm. For larger particles a shift towards higher wavelengths is observed as a function of increasing particle size.

An important feature of equation (1) is that the extinction coefficient shows a dependence on the dielectric constant of the surrounding material. The dielectric constant is related to the refractive index n (n=∈ₘ^{0.5}), which is roughly proportional to the density, at least in case of a non-absorbing medium. As the densities of substances are related to their temperature, the precise temperature dependence of the refractive index can be adjusted. The density may change due to thermal expansion as described by the thermal expansion coefficient or due a change of the volume of the material occurring during a phase change like melting. An increase of the specific volume of the transition material either due to a phase change or to thermal expansion as a result of an absorption of an applied irradiation causes a shift of the absorption peak as described by equation (1). This shift may lead to a higher absorption of the applied irradiation which causes the material to be further heated which leads to a further shifting of the peak. Thus the effect may be accelerating itself.

In an embodiment of an optical data carrier said thermochromic layer further comprises a recording material, so that said thermochromic layer is adapted for recording of data. If recording material and thermochromic material are combined or mixed together in one layer the absorption of the thermochromic material improves or even enables the recording of information in said recording material and/or the read-out quality of said information.

In another embodiment said optical data carrier further comprises an information layer, wherein said thermochromic layer is arranged adjacent to said information layer for improving a read-out quality and/or a recording sensitivity of said information layer. In order for said improvement said information layer and said thermochromic layer may also be different layers.

In a further embodiment of an optical data carrier said metal nano-particles are made of gold, silver and/or palladium. The production of nano-particles made of these metals is rather common, and there are a number of suitable methods for producing said nano-particles.

In a preferred embodiment of an optical data carrier said nano-particles have a size of 300 nm or less, preferably 100 nm or less. In general, the wavelength of the absorption peak is shifted to higher wavelengths when said nano-particles become larger. However, it is important that said nano-particles are within a range of size in which they can exhibit the effect of surface plasmon resonances, which are absent in the individual atom as well as in the bulk.

In another embodiment of an optical data carrier a thickness of said thermochromic layer is in the range of 10-2000 nm, in particular in the range of 50-500 nm, preferably in the range of 50-100 nm.

In another embodiment of an optical data carrier weight fraction of said nano particles in said thermochromic layer is in the range of 2-90%, in particular in the range of 10-80%, preferably in the range of 50-80%.

If said thermochromic layer is thick, the concentration or weight fraction of said nano-particles may be lower, and vice versa, to achieve a suitable absorption of said irradiation. The concentration and the thickness can be chosen such that the maximum absorbance from the layer is in the range of 0.1-2, preferably in the range of 1-2.

In a yet further embodiment of an optical data carrier said nano-particles are made of mixture of different metals and/or have different sizes for increasing the bandwidth of said absorbing of said irradiation by said thermochromic layer.

In another embodiment of an optical data carrier said nano-particles substantially have a shape of a disc or a rod for increasing the bandwidth of said absorbing of said irradiation of said thermochromic layer and/or for changing the position of a peak of said absorbing.

In a further embodiment of an optical data carrier said transition temperature is lower than a temperature needed for said recording of data. If the thermochromic effect starts at a lower temperature than the recording the whole area of a recording spot may take benefit of said thermochromic effect.

In a preferred embodiment of an optical data carrier said transition material is substantially non-absorbant to said irradiation. Thus, there will be no loss of intensity of said irradiation even when said irradiation passes a number of thermochromic layers.

In another embodiment of an optical data carrier said transition material is a linear polymer, in particular polystyrene polycarbonate, a crosslinked acrylate epoxy resin, or glass forming low mass molecules.

In the following, the invention will be explained further in detail with reference to the figures, in which:

FIG. 1 shows a cross-section of an embodiment of an optical data carrier comprising thermochromic layers according to the present invention,

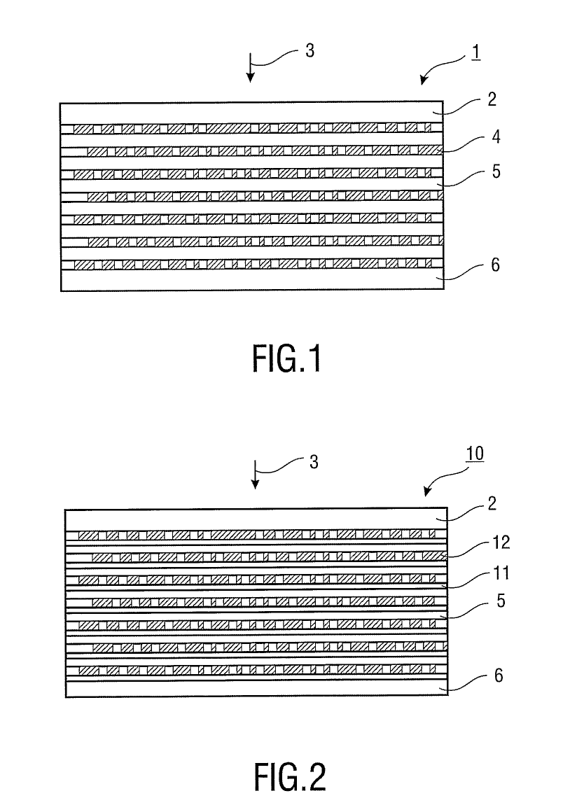

FIG. 2 shows a cross-section of another embodiment of an optical data carrier comprising thermochromic layers according to the present invention,

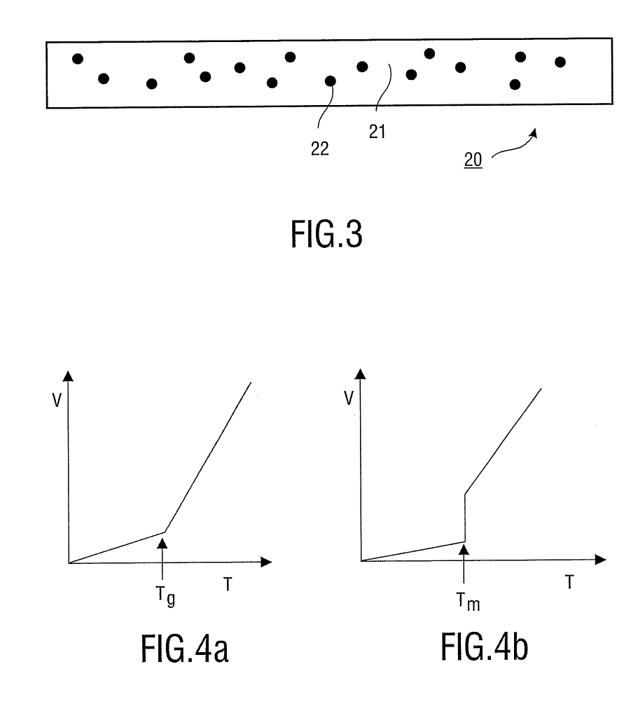

FIG. 3 shows a cross-section of an embodiment of a thermochromic layer according to the present invention,

FIGS. 4a, 4b show graphs illustrating specific volume versus temperature for a glass transition and for melting, respectively,

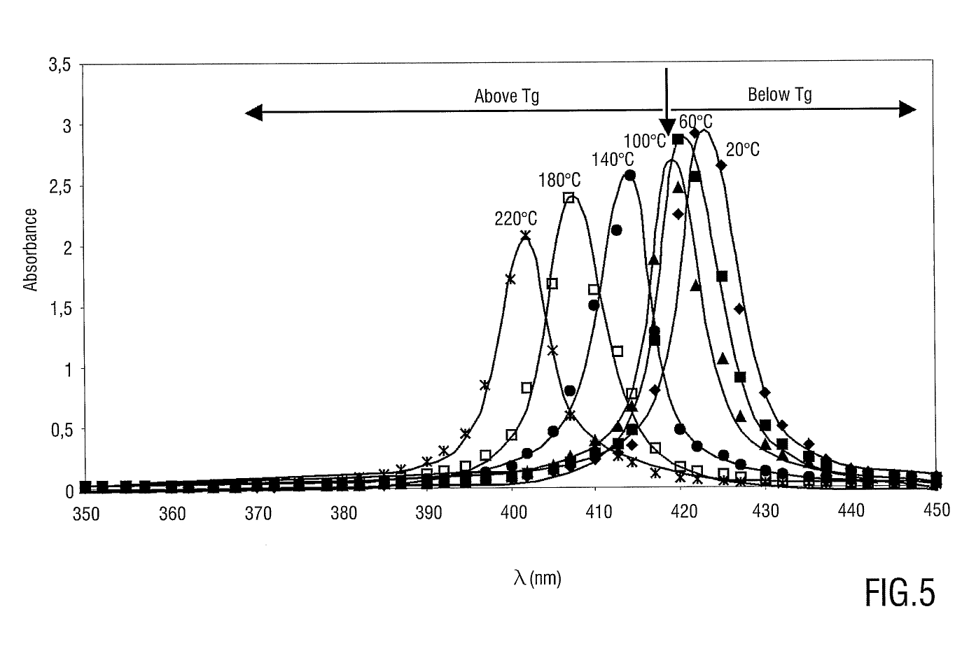

FIG. 5 shows a graph illustrating the absorbance versus wavelength of absorbed light of a thermochromic layer according to the present invention above and below a glass transition temperature,

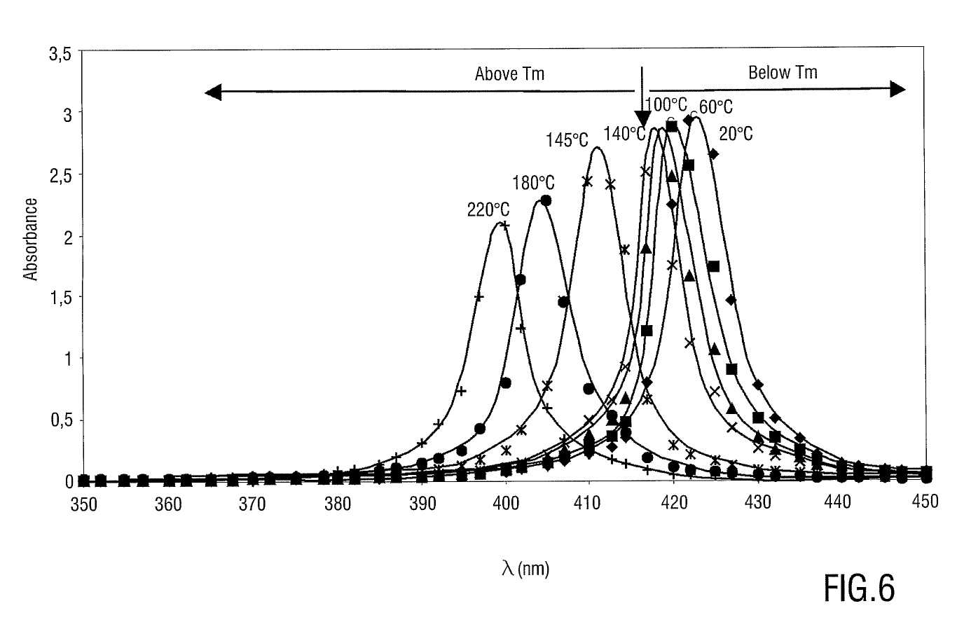

FIG. 6 shows a graph illustrating the absorbance versus wavelength of absorbed light of a thermochromic layers according to the present invention above and below a melting temperature,

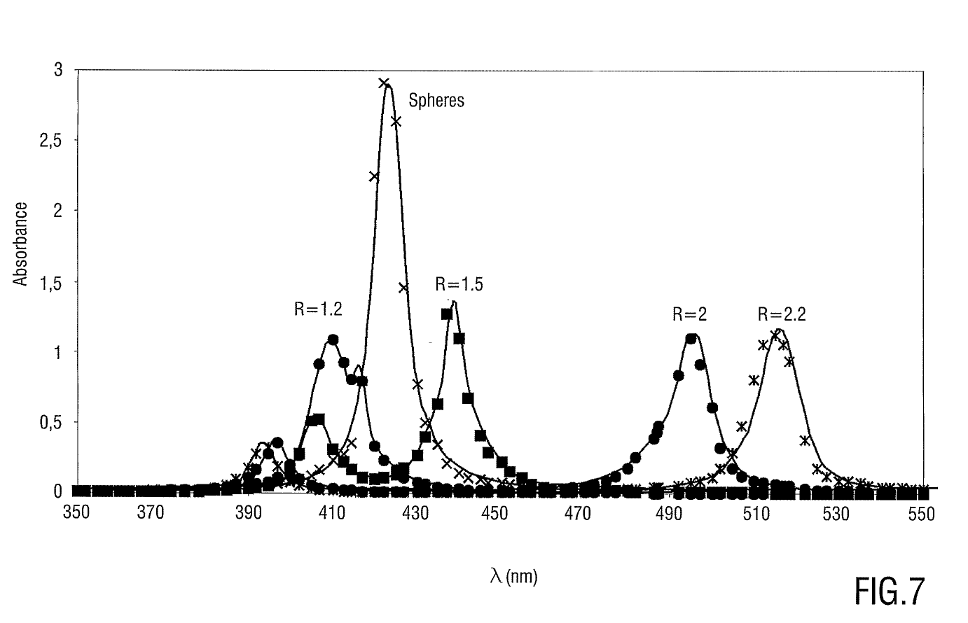

FIG. 7 shows a graph illustrating the absorbance versus wavelength of absorbed light of thermochromic layers according to the present invention with different dimension ratios,

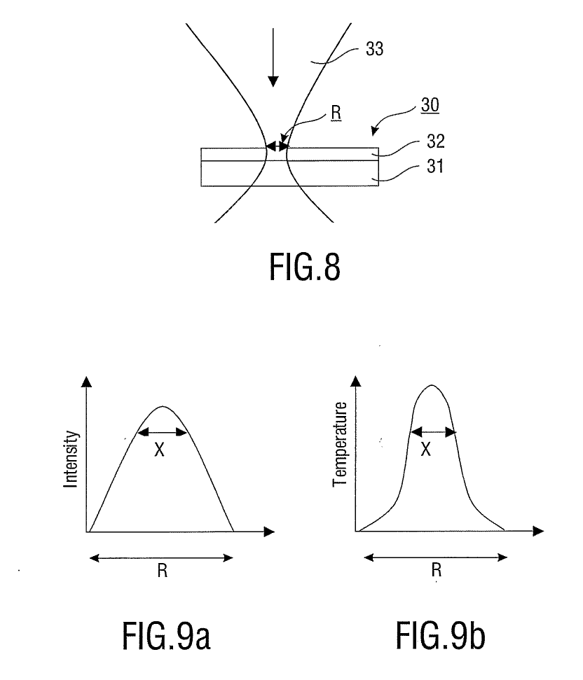

FIG. 8 shows a cross-section of an optical master according to the present invention, and

FIGS. 9a, 9b show graphs illustrating an intensity profile and a temperature profile of an optical spot.

FIG. 1 shows a cross-section of an embodiment of an optical data carrier 1 comprising thermochromic layers 4 according to the present invention. On top of the carrier 1 a cover layer 2 for protection is provided, onto which an optical beam 3, such as a laser beam or light generated by LEDs, is incident. Thereafter a number of thermochromic stacks, in the present example 7 thermochromic stacks, each comprising a single thermochromic layer 4 are provided. The thermochromic stacks, and thus also the thermochromic layers 4, are separated by spacer layers 5 to optically and thermally separate adjacent thermochromic layers. Below the deepest thermochromic layer 4 a substrate 6, e.g. of polycarbonate, is provided. In the illustrated embodiment the thermochromic layers 4 further include a recording material, so that they have the functionality of recording layers. Data may be stored utilizing the recording material.

FIG. 2 shows a cross-section of another embodiment of an optical data carrier 10 comprising thermochromic layers 11 according to the present invention. The embodiment shown in FIG. 2 is similar to that of FIG. 1. The difference is that said optical data carrier further comprises information layers 12 arranged adjacent said thermochromic layers 11. Said thermochromic layers 11 may or may not include further recording material as illustrated in FIG. 1. The thermochromic layers 11 are adapted for improving a read-out quality and/or a recording sensitivity of said information layers 12. Configurations different from those shown in FIGS. 1 and 2 are also possible, in particular as a different order of information layers 12, thermochromic layers 11 and spacer layers 5.

FIG. 3 shows a cross-section of an embodiment of a thermochromic layer 20 according to the present invention. The thermochromic layer 20 includes a dielectric thermochromic material comprising a transition material 21 and metal nano-particles 22 embedded in said transition material. The transition material 21 is, for example, a linear polymer such as polystyrene polycarbonate or a crosslinked acrylate epoxy resin. The dielectric constant of said transition material 21 and its density are related. Further, it may preferably be transparent, i.e. non-absorbant, to said irradiation, at least in comparison to said nano-particles 22. The nano-particles 22 are preferably made of gold, silver or palladium, but any other metal may also be used. Since both, glass transition and melting, are fast and reversible processes which in general do not change their transition temperature, the thermochromic effect according to the present invention is fast and stable. The nano-particles 22 may have another shape than the spherical shape illustrated in FIG. 3, for example rod-like or disc-like as described below.

FIGS. 4a, 4b show graphs illustrating specific volume versus temperature for a glass transition and for melting, respectively. Temperature T and volume V are shown with arbitrary units. Due to thermal expansion the volume V increases below a transition temperature T_{g} or Tₘ with a rather small slope corresponding to a rather small thermal expansion coefficient. Beyond said transition temperature T_{g}, Tₘ said thermal expansion coefficient is increased and thus the volume V increases with a larger slope. There is a step in, volume V due to a melting indicated in FIG. 4b. It is not necessary that the respective thermal expansion coefficients are constant below or above said transition temperature T_{g}, Tₘ, however, the thermal expansion coefficient above should be higher than the one below. It is further preferred that there is a change of a considerable extent. The invention is not limited to changes due to a glass transition or a phase change like melting. If there is no change in the thermal expansion coefficient but only a change in specific volume no auto acceleration will occur but nevertheless there is a non-linearity as there is a distinct shift in the absorbance of the thermochromic layer.

FIG. 5 shows a graph illustrating the absorbance versus wavelength of absorbed light of a thermochromic layer according to the present invention above and below a glass transition temperature. Curves indicating the absorbance for different temperatures were calculated according equation (1) and are shown in FIG. 5. A thermal expansion coefficient was set to be 2×10⁴ K⁻¹ below a (glass) transition temperature T_{g} of 100° C. changing to 8×10⁻⁴ K⁻¹ above that temperature. It can be seen that up to the (glass) transition temperature T_{g} of the surrounding medium the position of the absorption band shows only a slight change. Above the glass transition temperature it shows a rapid shift.

FIG. 6 shows a graph illustrating the absorbance versus wavelength of absorbed light of a thermochromic layer according to the present invention above and below a melting temperature. Curves indicating the absorbance for different temperatures were calculated according equation (1) and are shown in FIG. 6. The changes of the thermal expansion coefficient are schematically shown in FIG. 4b. It can be seen in FIG. 6 that up to the melting temperature the position of the absorption band shows only a slight change whereas above the melting temperature there is at first a rather large jump followed by a rapid shift towards shorter wavelengths.

FIGS. 4a, 4b, 5 and 6 indicate that by adjusting the temperature dependence of the specific volume a desired thermochromic behaviour can be obtained. For example, as it can be seen from FIG. 5, at 20° C. there is a very small absorbance of a wavelength of 405 nm, thus a very high intensity is needed so that a sufficient amount of energy can be absorbed to heat up the thermochromic material. If the intensity is high enough to heat the thermochromic material to a temperature above the transition temperature T_{g} the absorbance will increase considerably so the material will be further heated leading to a higher absorbance. The auto acceleration is limited to the area where the intensity is high enough to reach the transition temperature, in other words, where the intensity is above a certain threshold.

From FIGS. 5 and 6 it can be seen that the size of the band or the bandwidth is rather small. One way of widening the bandwidth is by using nano-particles 22 of various sizes or mixing particles 22 made of two or more metals. As described above larger nano-particles 22 exhibit absorbance at higher wavelength. Mixing nano-particles 22 of different sizes allows to combine the different absorbances related to the different sizes and thus to achieve a larger bandwidth. It is also possible to mix particles of different metals. In this way the bandwidth may also be increased.

Another way for making the band broader or increasing the absorption is to use rod or disc like particles. According to the Gans theory the extinction coefficient κ for N particles of Volume V is given by the equation below:

$$κ = \frac{2 π NV {ɛ}_{m}^{1.5}}{3 λ} {\sum }_{j} \frac{( 1 / {P}_{j}^{2} ) {ɛ}_{2}}{{( {ɛ}_{1} + \frac{1 - {P}_{j}}{{P}_{j}} )}^{2} {ɛ}_{m} + {ɛ}_{2}^{2}} \qquad ( 2 )$$

The Pⱼ values are depolarisation factors for three axes A,B and C of nano-rods with dimensions A>B=C, which can be described by

$$\begin{matrix}{P}_{A} = \frac{1 - {e}^{2}}{{e}^{2}} [ \frac{1}{2 e} ln ( \frac{1 + e}{1 - e} ) - 1 ] & ( 3 ) \\ {P}_{B} = {P}_{C} = \frac{1 - {P}_{a}}{2} & ( 4 ) \\ e = \sqrt{1 - {( \frac{B}{A} )}^{2}} = \sqrt{1 - {( \frac{1}{R} )}^{2}} & ( 5 )\end{matrix}$$

with R=A/B. FIG. 7 shows a graph illustrating the absorbance versus wavelength of absorbed light of thermochromic layers according to the present invention with different dimension ratios, calculated using the above equations. It can be seen from FIG. 7 that by using nano-particles 22 of cylindrical shape like a rod or a disc it is possible to increase the bandwidth (see R=1.2 in FIG. 7) as well as changing the position of the absorption band.

FIG. 8 shows a cross-section of an optical master 30 according to the present invention comprising a substrate 31 and a thermochromic layer 32. An irradiation beam 33, for example laser light, is focused to said thermochromic layer and thus forms an optical spot thereon with a size as indicated by R. Said thermochromic layer may include a photo-sensitive material like the one commonly used for optical masters, as for example a UV-curable resin, for manufacturing a track of pits and lands. It is also possible that there is a further layer of said photo-sensitive material provided for that purpose. Said optical spot may exhibit an intensity distribution as schematically shown in FIG. 9a which may lead to a temperature distribution as shown in FIG. 9b. By using a thermochromic layer according to the invention it is possible by selecting a suitable transition temperature to enhance the sensitivity to the temperature so that a recording spot is achieved with a size indicated by X which is smaller than that of the optical spot. Thus, the formed land or pit may be smaller than said optical spot. There is further a well defined border to this recording spot since only that part of the temperature profile shown in FIG. 9b which is above the selected transition temperature results in said recording spot.

The present invention proposes an optical data carrier and an optical master for manufacturing an optical data carrier both comprising a thermochromic layer, wherein properties of the thermochromic layer like bandwidth of the absorbance and position of the band of absorbance can be adjusted to a desired value as well as a temperature above which a thermochromic effect will start. The thermochromic effect itself is fast and stable.

A change in density induces a change in the refractive index which in return causes a change in absorption. Above a transition temperature a this change in absorption becomes stronger and a thermochromic effect occurs as soon as light becomes absorbed. Increasing the temperature tends to increase the volume increase so that an autoacceleration may occur. However, a decrease in volume could also cause the same effect.

1. Optical data carrier (1, 10) comprising a thermochromic layer (4, 11, 20) including a dielectric transition material (21) and metal nano-particles (22) embedded in said transition material (21) for absorbing at least a part of an irradiation (3) applied to said optical data carrier (1, 10) for reading out data from said optical data carrier (1, 10) and/or for recording data on said optical data carrier (1, 10), characterized in that said transition material (21) has a first value of a material characteristic being a specific volume and/or a thermal expansion coefficient of said transition material (21) below a transition temperature (T_{g}, Tₘ) and a second value of said material characteristic above said transition temperature (T_{g}, Tₘ), said second value being higher than said first value.

2. Optical data carrier (1) as claimed in claim 1, characterized in that said thermochromic layer (4) further comprises a recording material, so that said thermochromic layer is adapted for recording of data.

3. Optical data carrier (10) as claimed in claim 1, further comprising an information layer (12), wherein said thermochromic layer (11) is arranged adjacent to said information layer (12) for improving a read-out quality and/or a recording sensitivity of said information layer (12).

4. Optical data carrier (1, 10) as claimed in claim 1, characterized in that said metal nano-particles (22) are made of gold, silver and/or palladium.

5. Optical data carrier (1, 10) as claimed in claim 1, characterized in that said nano-particles (22) have a size of 300 nm or less, preferably 100 nm or less.

6. Optical data carrier (1, 10) as claimed in claim 1, characterized in that a thickness of said thermochromic layer is in the range of 10-2000 nm, in particular in the range of 50-500 nm, preferably in the range of 50-100 nm.

7. Optical data carrier (1, 10) as claimed in claim 1, characterized in that a weight fraction of said nano-particles (22) in said thermochromic layer (4, 11, 20) is in the range of 2-90%, in particular in the range of 10-80%, preferably in the range of 50-80%.

8. Optical data carrier (1, 10) as claimed in claim 1, characterized in that said nano-particles (22) are made of a mixture of different metals and/or have different sizes for increasing the bandwidth of said absorbing of said irradiation (3) by said thermochromic layer (4, 11, 20).

9. Optical data carrier (1, 10) as claimed in claim 1, characterized in that said nano-particles (22) substantially have a shape of a disc or a rod for increasing the bandwidth of said absorbing of said irradiation (3) of said thermochromic layer (4, 11, 20) and/or for changing the position of a peak of said absorbing.

10. Optical data carrier (1, 10) as claimed in claim 1, characterized in that said transition temperature (T_{g}, Tₘ) is lower than a temperature needed for said recording of data.

11. Optical data carrier (1, 10) as claimed in claim 1, characterized in that said transition material (21) is substantially non-absorbant to said irradiation (3).

12. Optical data carrier (1, 10) as claimed in claim 1, characterized in that said transition material (21) is a linear polymer, in particular polystyrene polycarbonate, a crosslinked acrylate epoxy resin or glass forming low mass molecules.

13. Optical master (30) for manufacturing optical data carrier, said optical master comprising a thermochromic layer (20, 32) including a dielectric transition material (21) and metal nano-particles (22) embedded in said transition material (21) for absorbing at least a part of an irradiation (33) applied to said optical master (30) for recording data on said optical master (30), characterized in that said transition material (21) has a first value of a material characteristic being a specific volume and/or a thermal expansion coefficient of said transition material (21) below a transition temperature (T_{g}, Tₘ) and a second value of said material characteristic above said transition temperature (T_{g}, Tₘ), said second value being higher than said first value.
